(19) United States
(12) Patent Application Publication
(10) Pub. No.: US 2009/0218455 A1
(43) Pub. Date: Sep. 3, 2009

(54) BALANCING APPARATUS FOR A SURGICAL MICROSCOPE

(76) Inventor: Andrzej Metelski, Romanshorn (CH)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(21) Appl. No.: 12/371,440

(22) Filed: Feb. 13, 2009

(30) Foreign Application Priority Data
Feb. 28, 2008 (DE) 102008011640.8-56

(51) Int. Cl. F16M 11/06

(52) U.S. Cl. 248/122.1

(57) ABSTRACT

A balancing apparatus for a surgical microscope is suggested balancing an optics carrier with and without a microscope holder holding the surgical microscope and with and without add-on units. The optics carrier is connected via a pivot support to a stand and rotatable around a first rotational axis in relation to the pivot support. The balancing apparatus comprises a Y displacement unit comprising a first slide for displacement of the optics carrier in a Y direction; and a Z displacement unit comprising a second slide for displacement of the optics carrier in a Z direction. The weight of the second slide acts as a compensation weight for compensating the weight of the optics carrier with and without the microscope holder holding the surgical microscope and with and without the add-on units.

### CROSS-REFERENCE TO RELATED APPLICATION

This application claims the priority of the German patent application DE 102008011640.8 having a filing date of Feb. 28, 2008, the entire content of which is herewith incorporated by reference.

### BACKGROUND OF THE INVENTION

The invention relates to a balancing apparatus for a surgical microscope that is held via a pivot support on a stand.

“Stands” for purposes of the invention are any retaining systems on the floor, wall, or ceiling that are suitable for carrying a balancing apparatus according to the present invention or a surgical microscope.

As is known, surgical microscopes should be very easy to move, and quickly displaceable without a great expenditure of energy. To ensure that the surgical microscope does not move on its own once a position is established, the forces and moments occurring in any position must be equalized (balanced). If the surgical microscope is not sufficiently equalized (balanced), however, brakes or bracing devices, which disadvantageously increase the overall weight of the structure, must be present. The forces and moments should be balanced out even when brakes are present, however, in order to enable easy movement of the surgical microscope when the brakes are released.

On the other hand, the use of a surgical microscope normally involves utilization of a wide variety of different exchangeable accessories (e.g. tubes, extensions, filters, auxiliary lenses, etc.). This results in most cases, however, in a shift of the overall center of gravity. As a result, the system is no longer in equilibrium and must therefore be balanced out again. The basic goal when balancing is to keep the overall center of gravity of the movable surgical microscope on its pivot axis or axes.

DE 10133018 A1 (of the same Applicant) describes one such arrangement, in which an optics carrier along with a surgical microscope are rotatable about a horizontal axis (A axis). They need firstly to be balanced out with reference to this A axis so that when the brakes are released, a surgeon can as easily as possible, i.e. with as little resistance and torque as possible, rotate the optics carrier (and thus the microscope) about this A axis. This A axis is usually configured on the lower part of the pivot support and is equipped with a brake unit or locking unit that prevents any rotary movement of the optics carrier, and therefore of the surgical microscope, with reference to the pivot support. Installed between the optics carrier and the pivot support is a balancing unit with which the optics carrier along with the surgical microscope can be balanced out about the horizontal A axis in the Y and the Z direction.

The apparatus according to DE 10133018 A1 (FIG. 2) is made up of two slides that are interconnected. One of them is displaceable in the Y direction and the other in the Z direction, each by means of a displacement unit, and they can be immobilized in a position that is established. Arranged at the upper end of the pivot support is a further displacement unit that enables an additional displacement in the X direction (parallel to the A axis) (FIG. 2).

The solutions in accordance with DE 10133018 A1 (FIGS. 2 and 3) have not yet been utilized in practice. A similar approach has, however, been implemented and disclosed in the Applicant's MC1 stand. With this approach, the Y-Z displacement unit made up of the two slides arranged one above another was mounted on the A axis in such a way that the Z slide was mounted directly on the A axis, and the Y slide was mounted on the one hand directly on the Z slide and on the other hand on the optics carrier. As in the case of FIG. 2 of DE 10133018 A1, the X slide was mounted above the pivot arm.

This construction has proven substantially successful. It had one disadvantage over the years, however: In order to enable sufficient balancing for the surgeon even, and especially, in those configurations of the system in which, for example, assistant's tubes or lateral add-on units are to be attached, a consequence of the above arrangement is nevertheless that these add-on units can collide, during the balancing procedure, with the slide that is responsible for vertical displacement. The freedom of movement of the surgical microscope is therefore limited. On the other hand, homogeneity of the movements is thereby also reduced as a result of the imbalance that occurs.

In accordance with the existing art in the context of the MC1, the balancing-out procedure was made easier by attaching an add-on weight that, with a mass of approximately 3.5 kg, was attached on the side of the optics carrier located opposite the add-on units of the microscope, where it balanced out the add-on units across the pivot axis.

The disadvantage of this weight compensation is that it considerably increases the total weight, which results in increased inertia when pivoting. Installation or removal of this add-on weight also required additional effort. This method is therefore time-consuming, and moreover results in increased forces and moments on the stand as a whole because of the greater total weight (see e.g. EP-0476551 A1). The add-on weight produces not only an increase in torque (moment of resistance to rotation) during the displacement procedure, but also greater friction in every bearing of the entire stand, thus increasing the overall inertia of the stand and limiting its mobility. Homogeneity of the movements of the stand is also thereby reduced. In addition, the dimensions of the stand (and of all other load-bearing components) of course also had to be correspondingly enlarged, which in turn considerably increased the total weight of these components and thus also the cost of the stand. Lastly, the add-on weight is visible as an additional part having no apparent function, and as a result can also be undesirable or can interfere with the user's field of view. It has therefore been referred to colloquially for some time as a “spoiler.”

In the most up-to-date surgical practice, surgical microscopes and their stands not only need to meet standard requirements in terms of optical quality, bright illumination, compact design, and maximum flexibility, but also must incorporate novel aspects. Consideration must now be given, for example, to the fact that the number of surgical operations per day, and the utilization intensity of expensive surgical equipment, has risen. The time needed to set up a surgical microscope for the next operation is becoming increasingly important. As an essential component of the operating-room infrastructure, the surgical microscope has a significant influence on costly preparation time.

The known OH4 and OH5 stands of the Mitaka company also possess Y and Z displacement units, which are motor-equipped but do not solve the existing problems recited above.

The object underlying the invention is therefore that of creating an improved apparatus that enables relatively faster and simpler, and complete, balancing of the surgical microscope without an add-on weight, and that significantly reduces or eliminates the aforementioned disadvantages of the existing art. The intention is therefore for all possible configurations of the surgical microscope to be as easy as possible for the surgeon to balance out.

### SUMMARY OF THE INVENTION

The inventor has recognized that achieving the stated object requires at least a reduction of weight in the region of the optics carrier, without limiting movements for a precise balancing procedure. In particular, the additional compensation weight (spoiler) should be removed. This object is not achieved or suggested by any of the known balancing devices, especially because this object had not hitherto been stated in any of the known documents (including DE 10133018 A1) of the existing art.

In addition to replacement of the add-on weight, a further intention is therefore to prioritize weight saving, cost reduction, and smooth operation of the stand.

This object is achieved, according to the present invention, by a balancing apparatus for a surgical microscope, for balancing an optics carrier connected via a pivot support to a stand, said optics carrier being rotatable around a first rotational axis in relation to the pivot support; said balancing compensating for the use with and without a microscope holder holding the surgical microscope and with and without add-on units, the balancing apparatus comprising: a Y displacement unit comprising a first slide for displacement of the optics carrier in a Y direction; and a Z displacement unit comprising a second slide for displacement of the optics carrier in a Z direction, wherein the first slide provides for displacement of the optics carrier in a direction transversely to the first rotational axis and transversely to the displacement by the second slide in the Z direction; and the weight of the second slide acts as a compensation weight for compensating the weight of the optics carrier with and without the microscope holder holding the surgical microscope and with and without the add-on units.

### BRIEF DESCRIPTION OF THE DRAWINGS

The invention will be further explained, symbolically and by way of example, with reference to the attached drawings, in which:

FIG. 1 is a side view of a symbolic overall configuration of a stand for and having the surgical microscope having a balancing apparatus according to the present invention;

FIG. 2 is a perspective view, at enlarged scale, of a portion of the stand having the surgical microscope according to FIG. 1, and of the balancing apparatus;

FIG. 3 is a schematic front view of the approach according to FIG. 2 viewed in the Y direction, but having only one eyepiece.

### DETAILED DESCRIPTION OF THE DRAWINGS

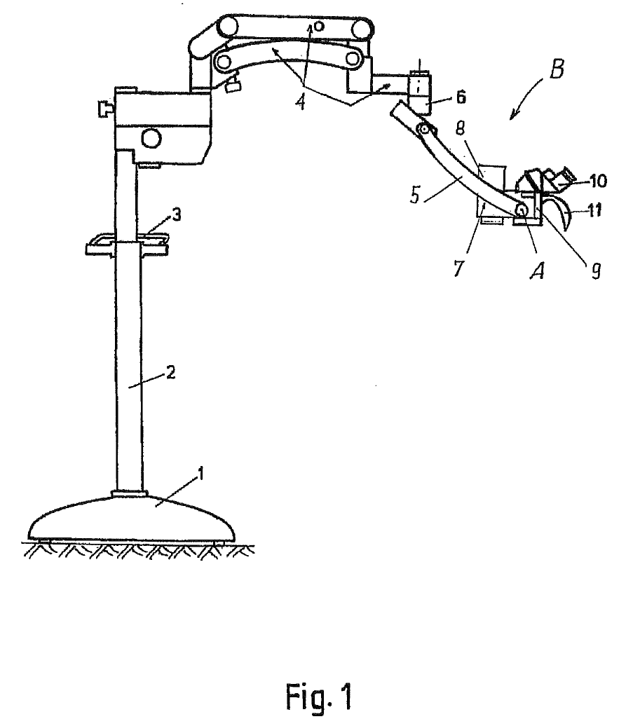

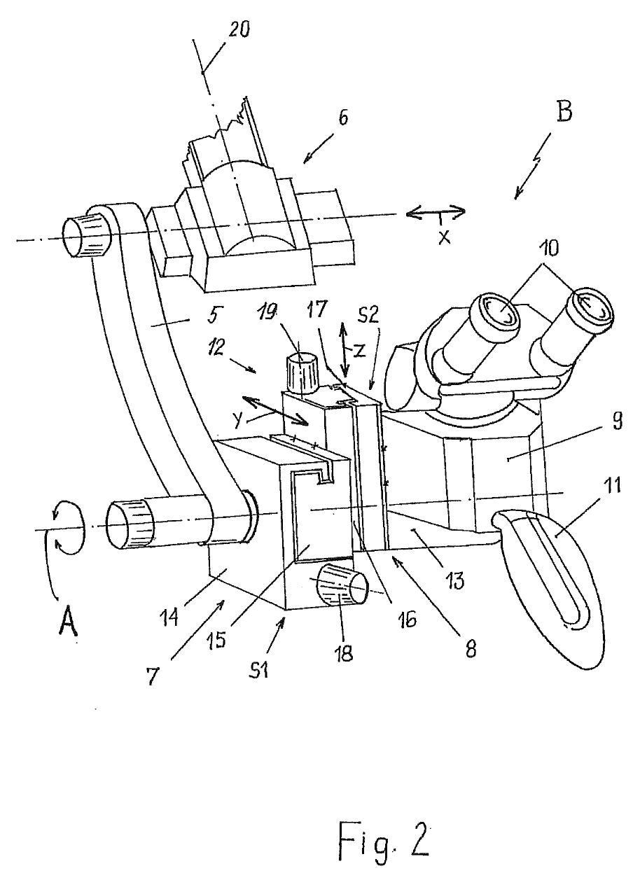

FIG. 1 is a side view depicting a schematic overall structure of an exemplifying embodiment of the stand having a surgical microscope. The stand is equipped with a stand base 1 known per se (optionally on lowerable or retractable casters that are not depicted), a vertical support 2, and a grip 3 for moving the stand. A horizontal support unit 4 known per se is arranged at the upper end of vertical support 2. In this embodiment, an X displacement unit 6 is arranged at the free end of horizontal support unit 4, enabling displacement in the X direction of a pivot support 5 and of Y and Z displacement units 7 and 8 installed at its lower end, and of an optics carrier 9 mounted on Z displacement unit 8. As a result of this displacement, the optics carrier having the surgical microscope can be balanced about a vertical or obliquely extending axis 20 (FIG. 2). As not depicted in the Figures but as present in the MC1, the X displacement unit is equipped with drive systems or rotary knobs, comparable to 18 and 19 in FIG. 2, that serve for X displacement.

The stand can be embodied as a floor or wall stand, or a ceiling mount. It is depicted as a floor stand merely by way of example.

X, Y, and Z displacement units 6 to 8 together constitute a balancing apparatus B that is associated with pivot support 5. Manual balancing displacements, for example, can be carried out quickly and exactly by means of the specific configuration and arrangement of balancing apparatus B (see also FIG. 2) and in particular of slides S1 and S2 according to the present invention.

An eyepiece of the microscope is labeled 10, and a handle for manual displacement of the surgical microscope is labeled 11. The use of handle 11 as depicted is merely an example. It would also be possible advantageously, in a manner already known per se on the aforementioned MC1, for a two-part, two-sided handle to be provided, i.e. one handle for the left hand and one for the right. It is usual also to arrange on such handles (in a manner similar to motorcycle grips) electrical switch knobs or the like that enable, for example, selective release or actuation of brakes and/or application of control to the illumination system or the like.

FIG. 2 shows, in perspective, a portion of the structure of pivot support 5 and of the stand parts for the surgical microscope in the region of optics carrier 9, as well as balancing apparatus B itself. It is clearly apparent here that one portion of balancing apparatus B, i.e. X displacement unit 6 for horizontal displacement in the X direction, is arranged, in a manner segregated from the Y-Z displacement system, at the upper end of pivot support 5 (as in the embodiment according to FIG. 2 of DE 10133018 A1 cited above).

The essence of the invention lies in the particular configuration and arrangement of the further parts of balancing apparatus B, i.e. Y displacement unit 7 for displacement in the Y direction, and Z displacement unit 8 for displacement in the Z direction, which are interconnected at the lower end of pivot support 5 and arranged rotatably about a horizontal A axis A and in a manner allowing immobilization in any rotational position that is established.

According to the present invention Y displacement unit 7, and Z displacement unit 8 coacting therewith, of balancing apparatus B are embodied as a cross-slide 12, a first slide S1 (depicted and positioned horizontally in FIG. 2) of cross-slide 12 being provided as part of Y displacement unit 7, and a second slide S2 (depicted and positioned vertically in FIG. 2) of cross-slide 12 being provided as part of Z displacement unit 8.

An essential feature of the invention is the fact that first slide S1 of cross-slide 12 is arranged, as part of Y displacement unit 7, transversely to A axis A directly alongside pivot support 5 and adjoins second slide S2 of cross-slide 12, as part of Z displacement unit 8, adjacently to Y displacement unit 7 (to the right thereof in FIG. 2), and carries a microscope holder 13 that receives an optics carrier 9.

This configuration is preferred. Optics carrier 9 could, however, also be connected directly to slide S2. What is visible in FIG. 2 of the surgical microscope itself is optics carrier 9, eyepieces 10, and handle 11.

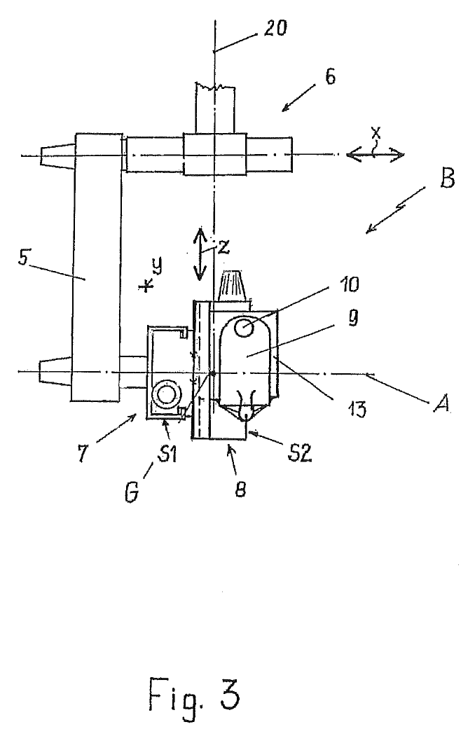

The exemplifying details of cross-slide 12 are visible in FIGS. 2 and 3. First slide S1 encompasses a horizontal guidance element 14 and an insert 15 arranged therein in axially shiftable or displaceable fashion. Second slide S2 is equipped in similar fashion with a vertical guidance element 16 and an insert 17 axially shiftable or displaceable therein. For coaction of the two slides S1 and S2 of cross-slide 12, horizontal insert 15 of slide S1 is connected to vertical guidance element 16 of slide S2 to yield a cross-slide 12 (FIGS. 2 and 3). In this instance, according to a particular configuration, microscope holder 13 is detachably mounted on the vertically shiftable insert 17 of slide S2.

In FIG. 2, Y displacement unit 7, and Z displacement unit 8 coacting therewith, of balancing apparatus B are equipped with a respective knob 18, 19 (comparably to the MC1) for manual displacement and immobilization. In FIGS. 2 and 3, an obliquely extending axis of the stand is labeled 20. Surgical microscope 9 with its pivot support 5 can be rotated about this axis 20 if the brake (not depicted) associated therewith is released. X displacement unit 6 serves for balancing the construction about this axis 20.

A “pivot support” is to be understood for purposes of the invention as that component or component group which is installed indirectly or directly on horizontal support unit 4 of the stand (FIG. 1) and which receives, via the (in principle, horizontal) A axis A, a microscope holder 13 on which optics carrier 9 is held. Two crosses between S2 and 9 indicate symbolically that insert 17 can also be mounted directly (detachably or nondetachably) on optics carrier 9.

FIG. 3 schematically depicts the arrangement according to the present invention of FIG. 2 in a front view. A completely balanced-out position of the surgical microscope in a vertical working position is symbolically shown here.

In this position, the common center of gravity G of optics carrier 9, with the respective accessories and with Y and Z displacement units 7 and 8, is located in rotation axis A and is thus balanced out across A (principal goal of the invention). Center of gravity G is, however, also simultaneously located in axis 20. This completely balanced-out configuration of the system is the preferred goal of a preferred variant embodiment of balancing apparatus B according to the present invention. What is novel and inventive with respect to the existing art is, in any event, the fact that the arrangement according to the present invention of slide S1 (Y displacement) on axis A alongside the pivot support, and the arrangement of slide S2 (Z displacement) on microscope holder 13 or on optics carrier 9, yield the following effect:

The weight of slide S2 now itself acts, in novel fashion and in accordance with the invention, as a weight that is also balanced across axis A in the Y direction. It thus acts as a compensation weight, as can best be gathered from FIG. 1. As a result of this surprisingly simple action (exchanging the slides for the Y and the Z direction in terms of the known configuration of the MC1 and the OH 4 and OH 5), the use of an add-on weight becomes inapplicable. The weight of the Z slide is in fact in the range of approximately 3.5 kg, so that the slide of itself almost exactly replaces the add-on weight.

This invention is particularly ingenious because the Z slide corresponds approximately to the weight of the Y slide, since not only has a replacement been found for the compensation weight, but furthermore the entire weight of the surgical microscope, together with cross-slides S1 and S2, is kept the same even though a much improved balancing behavior (lower weight) is now achieved with the same Y-Z displaceability. This surprising effect is intensified by the fact that for more than 10 years, the add-on weight in the MC1 was regarded by the technical community as the only possibility for practical balancing. The vertical arrangement of slide S1 with reference to A axis A, provided in novel fashion according to the present invention, results in a slender construction that entails little interference with vision and, when necessary, can also be relatively easily balanced out in the X direction.

When the surgical microscope is in service, the invention in the preferred variant configuration thus guarantees the three displacements necessary for balancing the system so that optics carrier 9, together with the add-on units, can be positioned and balanced at any time, and the necessary movements can be performed in three principal directions. The three principal directions X, Y, and Z are depicted in FIG. 3. The X direction proceeds from left to right in the plane of the drawing. The Y direction is perpendicular thereto and comes out of the plane of the drawing. The Z direction is perpendicular to both of the directions indicated, and also lies in the plane of the drawing. Any conceivable movement or rotary positioning in three dimensions can of course be performed, by means of handle 11, by way of the linear displacements combined with a 360-degree rotation capability of optics carrier 9 about axis A and about axis 20.

The respective position of optics carrier 9 is to be established with reference to a patient. In ENT procedures in particular (in contrast to brain operations), changes in position are often necessary in this context during the surgical operation. The balance behavior must always be optimal regardless of the particular pivot position of the surgical microscope in three dimensions. The invention ensures this.

Thanks to balancing apparatus B according to the present invention, in particular cross-slide 12 that is proposed, slides S1 and S2 can be made smaller and lighter overall. As a consequence of the weight displacement function taking place during the balancing procedure and resulting from the installation of slide S2, which is responsible for the vertical Z displacement of optics carrier 9, a balancing effect is produced directly on microscope holder 13 because of the dead weight of slide S2. The weight that needs to be balanced by means of slide S2 is now made up only of the weight of microscope 9 with any accessories, and of microscope holder 13 and slide S2.

Insert 15 of slide S1 responsible for the horizontal Y displacement is fixedly connected to guidance element 16 of slide S2 and thus also acts in part in weight-shifting fashion, since microscope holder 13, which receives optics carrier 9 (detachably, if necessary), is mounted on insert 17 (displaceable in the Z direction) of slide S2.

In the context of balancing apparatus B according to the present invention, the proposed construction and arrangement of cross-slide 12 has the advantage that the surgical microscope can be so precisely adjusted or balanced out that center of gravity G of the microscope, regardless of its configuration and any add-on units and regardless of its particular pivot position, is always located in A axis A and (if it is also balanced out in the X direction) in rotation axis 20. With this system the pivoting movement can therefore routinely be carried out more simply (without manipulation of add-on weights) and more easily (because of the lower total weight and hence lower frictional forces and resistance moments), and with higher working quality, than in the case of the existing art cited.

Based on experience so far, the present invention offers an improved surgical microscope that, in its balanced-out state, can be moved smoothly and, if necessary, with one hand. At the same time, however, it can also be adjusted exactly, quickly, and reliably by way of the manual balance adjustment system as soon as add-on units are installed on or removed from the surgical microscope. The preparation or refitting phase for utilization of the surgical microscope can thus be significantly shortened.

Also conceivable, according to a further development of the invention, is an embodiment of the invention (along the lines of FIG. 3 of DE 10133018 A1 cited above) in which X displacement unit 6 would also be arranged at the lower end of pivot support 5 in combination with Y and Z displacement units 7, 8 of balancing apparatus B. Here as well, however, a decisive factor for the invention in contradistinction to what is known is the fact that the Z displacement unit (S2) functions as a compensation weight on microscope holder 13 about axis A. Only thereby is the more-compact design according to the present invention achievable. If applicable, the vertically displaceable insert 17 of second Z slide S2, and optics carrier 9, can be embodied integrally. The horizontally displaceable insert 15 of first Y slide S1 could also be manufactured from a single piece along with vertical guidance element 16 of second Z slide S2. The design would be further integrated by these actions.

In the symbolic depictions of the invention, rotary knobs 18 and 19 are indicated for the operation of slides S1 and S2, respectively. Electrical drive systems could also be provided instead of these.

The invention is, of course, not limited to the exemplifying embodiments that are depicted and described. Further embodiments and combinations are also conceivable on the basis of our disclosure, within the scope of protection that is claimed. The Parts List below is a constituent of the disclosure.

Lastly, be it noted also that in the jargon used by those skilled in the art and by surgeons, the Y-Z slide is often referred to as an A-B slide. The X slide is then frequently referred to as a C slide.

The reader is furthermore referred to the detailed construction of the MC1—to which reference is hereby made and which is deemed incorporated hereinto by reference—for detailed embodiments of conventional brakes or locking devices on axes A and 20, and for the embodiment of grip 11 and the like.

Also referred to and incorporated by reference are the entire contents of Patent Applications DE 10 2008 011 639 and DE 10 2008 011 638, submitted on the same date.

### LIST OF COMPONENT PARTS

1 Stand base

2 Vertical support

3 Grip

4 Horizontal support unit

6 X displacement unit

7 Y displacement unit

8 Z displacement unit

9 Optics carrier

10 Eyepiece

11 Handle

12 Cross-slide

13 Microscope holder

14 Guidance element

15 Insert

16 Guidance element

17 Insert

18 Knob

19 Knob

20 Vertical oblique axis

A Rotation axis, A axis

B Balancing apparatus

G Common center of gravity

S1 First slide (Y)

S2 Second slide (Z)

X X direction

Y Y direction

Z Z direction

1. A balancing apparatus for a surgical microscope, for balancing an optics carrier connected via a pivot support to a stand, said optics carrier being rotatable around a first rotational axis in relation to the pivot support; said balancing compensating for the use with and without a microscope holder holding the surgical microscope and with and without add-on units, the balancing apparatus comprising:
a Y displacement unit comprising a first slide for displacement of the optics carrier in a Y direction; and
a Z displacement unit comprising a second slide for displacement of the optics carrier in a Z direction, wherein
the first slide provides for displacement of the optics carrier in a direction transversely to the first rotational axis and transversely to the displacement by the second slide in the Z direction; and
the weight of the second slide acts as a compensation weight for compensating the weight of the optics carrier with and without the microscope holder holding the surgical microscope and with and without the add-on units.

2. The balancing apparatus according to claim 1, wherein the optics carrier is connected displaceably to the second slide.

3. The balancing apparatus according to claim 1, wherein the first slide has a first guidance element and a first insert axially displaceable in that first guidance element; the first insert is mounted to a second guidance element of the second slide, the second guidance element has a second insert arranged axially displaceably in the second guidance element; and the second insert of the second slide is connected to the optics carrier.

4. The balancing apparatus according to claim 1, wherein the optics carrier, along with the axially displaceable slide of the Z displacement unit, is held by a microscope holder.

5. The balancing apparatus according to claim 3, wherein the second insert of the second slide and the optics carrier are integrally formed.

6. The balancing apparatus according to claim 3, wherein the first insert of the first slide is integrally formed with the second guidance element of the second slide.

7. The balancing apparatus according to claim 1, comprising an X displacement unit for displacement of the optics carrier in an X direction.

8. The balancing apparatus according to claim 7, wherein the X displacement unit comprises a second rotational axis that permits balancing of the pivot support along with the surgical microscope around the second rotational axis extending in an angle to the Z direction.

9. The balancing apparatus according to claim 8, wherein said angle differs from 90 degrees.

10. The balancing apparatus according to claim 8, wherein the first rotational axis is provided at a first end of the pivot support and the second rotational axis is provided at an opposite second end of pivot support.

11. The balancing apparatus according to claim 8, wherein the X displacement unit is arranged at the first rotational axis at a first end of the pivot support in combination with the Y and Z displacement units.

12. The balancing apparatus according to claim 1, comprising electric motors for driving the first and second slides.
